(19) United States
(12) Patent Application Publication
(10) Pub. No.: US 2024/0052152 A1
(43) Pub. Date: Feb. 15, 2024

(54) PVC FORMULATIONS WITH LOW WATER VAPOR PERMEABILITY

(71) Applicant: JOHNS MANVILLE, Denver, CO (US)

(72) Inventors: Diego Pedrazzoli, Littleton, CO (US); Jacob Lass, Denver, CO (US); Ames Kulprathipanja, Broomfield, CO (US)

(21) Appl. No.: 17/886,744

(22) Filed: Aug. 12, 2022

(51) Int. Cl. C08L 27/06; C08J 5/18

(52) U.S. Cl. CPC C08L 27/06; C08J 5/18; C08J 2327/06; C08L 2203/18; C08L 2201/14

(57) ABSTRACT

Described are rigid and semi-rigid polyvinyl chloride (PVC) films, layers, or sheets, and methods of forming the same. The PVC products includes polyvinyl chloride resin and at least one 2D filler incorporated at the micro- or nano-scale. The film can have a low water permeance, for example, lower than that of a traditional PVC film. The water permeance of the PVC film described in this invention is significantly lower than that of a PVC film specifically developed for pipe jacketing applications. Standard pipe jacketing applications use either PVC or metal jacketing in their systems. The invention described herein produces a finished PVC product with a low water permeance similar to that of the metal jacketing products specifically developed for pipe jacketing applications.

### BACKGROUND

Polyvinyl chloride (PVC) film, also referred to as a vinyl film, is a thin thermoplastic film available in a variety of forms and finishes. As used herein, the term films can refer to similar products, such as sheets and layers. PVC films have numerous applications, including jacketing applications to protect and insulate pipes, for example. PVC is highly durable, non-toxic, fire resistant, non-conductive, and relatively inexpensive. However, reducing the permeability of the polyvinyl chloride films, for example to water vapor, is a challenge. Current technologies for PVC films achieve water vapor permeance down to 0.05 perm. Achieving an even lower water vapor permeance would be beneficial, for example to allow PVC films to compete with the water vapor permeance of metals.

### BRIEF SUMMARY

The embodiments described herein include a polyvinyl chloride (PVC) film, layer, or sheet, and methods of forming the same. The PVC film includes polyvinyl chloride resin and at least one 2D filler incorporated at the micro- or nano-scale. The film can have a low water permeance, for example, lower than that of a traditional PVC film. In some embodiments, the PVC film has a water vapor permeance of 0.042 perm or less according to ASTM E96, for example at a film thickness of 0.508 mm (though embodiments can use other thicknesses), e.g., a water vapor permeance of 0.04 perm or less, a water vapor permeance of 0.03 perm or less, or a water vapor permeance of 0.02 perm or less. Consequently, embodiments can have permeability characteristics of 2.1 perms/inch or less, 1.5 perms/inch or less, or 1.0 perms/inch or less, for example. In some embodiments, the PVC resin is processed to reduce any filler or additive that is hydrophilic. In some embodiments, the PVC/2D filler film can have a thickness of from 0.05 mm to 3 mm.

In certain embodiments, the PVC resin of the film has a molecular weight, as expressed in K-value, of between 50 and 75, (e.g., from 52 to 65 or from 54 to 61). In some embodiments, the PVC resin of the film is selected such that it does not contain fillers or additives that are hydrophilic. The 2D filler particles can, in some embodiments, have an average length and width at least one order of magnitude greater than their average thickness, where the thickness can be in the nanometer range. In some embodiments, the at least one 2D filler can be present in an amount from 0.01 wt. % to 30 wt. %, based on the total weight of the film. Examples of the 2D filler include, but are not limited to graphene, graphite, clay, mica, montmorillonite, boron nitride nanosheets, boron nanosheets (B NSs), hexagonal boron nitride (h-BN), graphene oxide (GO), reduced graphene oxide (rGO), silicate clays, layered double hydroxides (LDHs), transition metal dichalcogenides (TMDs), transition metal oxides (TMOs), black phosphorus (BP), graphitic carbon nitride (g-C3N4), antimonene (AM), and tin telluride nanosheets (SnTe NSs), or combinations thereof. Nomenclature of these fillers may include the prefix “nano” (e.g., clay and nano-clay). In this invention, the selected fillers will be reported without prefix for simplicity.

In some embodiments, the PVC/2D filler film optionally comprises any or all combinations of a surfactant, a dispersing agent, and/or an acrylic processing aid. Examples of surfactants can include cationic surfactants (positively charged hydrophilic groups), anionic surfactants (negatively charged hydrophilic groups), zwitterionic surfactants (having both positively and negatively charged hydrophilic groups), and nonionic surfactants (the hydrophilic group has no charge), or combinations thereof. In some examples, the surfactant comprises Lubrizol Solplus DP700, Solplus DP310, or combinations thereof.

The PVC/2D filler films described can be used in various configurations. According to one embodiment, a film product includes a polyvinyl chloride (PVC) core layer that forms a bottom layer of the film product and a PVC cap layer positioned atop the PVC core layer so that the PVC cap layer forms a top layer of the film product. Either or both of the core and cap layers can comprise a 2D filler incorporated at the micro or nano scale, for example in an amount of from 0.01 wt. % to 30 wt. % based on the total weight of the layer. In some embodiments, either or both of the core and cap layers can have a thickness of 0.1 mm to 2 mm. In some embodiments, either or both of the core and cap layers can comprise up to 100 wt. % recycled PVC (e.g., from 5 wt. % to 100 wt. %, from 10 wt. % to 95 wt. %, from 20 wt. % to 90 wt. %). Such a film product could be used in pipe jacketing applications, for example.

In some embodiments, the PVC cap layer may include between 50 and 90 weight percent of the polyvinyl chloride resin, between 0.01 and 30 weight percent of the 2D filler, between 0.1 and 5 wt. % of a heat stabilizer (e.g. metallic stearate) (if present), between 0.01 and 2 wt. % of an internal and/or external lubricant based on polyethylene (if present), between 0.1 and 10 wt. % of TiO₂ (if present), between 0.1 and 30 wt. % of calcium carbonate (if present), between 0.1 and 15 wt. % of an acrylic impact modifier (if present), between 0.01 and 2 wt. % of an additional internal and/or external lubricant (if present), and between 0 and 5 wt. % percent of an acrylic processing aid. The acrylic processing aid may include a fusion aid, a lubricating processing aid, a high molecular weight lubricant, a combination of said materials, and the like, for example.

According to another embodiment, a method of making a film product includes extruding a first PVC material to form a PVC core layer of the film product and extruding a second PVC material atop the PVC core layer to form a PVC cap layer of the film product. Either or both of the core and cap layers can comprise a 2D filler incorporated at the micro- or nano-scale, for example in an amount of from 0.01 wt. % to 30 wt. % based on the total weight of the layer. In some embodiments, either or both of the core and cap layers can have a thickness of 0.1 mm to 3 mm. The PVC of the cap and/or core layer can include polyvinyl chloride resin having a molecular weight, as expressed in K-value, of between 50 and 75, for example.

### BRIEF DESCRIPTION OF THE DRAWINGS

The present technology is described in conjunction with the appended figures:

FIG. 1 illustrates a film product including a PVC cap and a bottom layer, such as a PVC core.

FIG. 2 illustrates a cross sectional representative region of a PVC film product.

FIG. 3 shows scanning electron microscope (“SEM”) images of cross sections of the PVC films.

FIG. 4 illustrates a method of making or forming a film product.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

The embodiments described herein relate to PVC films, sheets, and/or layers, and specifically to PVC films, sheets, and/or layers (collectively referred to as “films” herein) that include a polyvinyl chloride (PVC) polymer or resin and a 2D filler incorporated at the micro- or nano-scale. The PVC/2D filler films disclosed can offer excellent permeance (e.g., water vapor permeance). For example, the PVC/2D filler films can have a water vapor permeance of 0.042 perm or less (e.g., 0.040 perm or less, 0.038 perm or less, 0.036 perm or less, 0.034 perm or less, 0.032 perm or less, 0.030 perm or less, 0.028 perm or less, 0.026 perm or less, 0.024 perm or less, 0.022 perm or less, 0.020 perm or less, 0.018 perm or less, 0.016 perm or less, 0.014 perm or less, 0.012 perm or less, 0.024 perm or less, 0.010 perm to 0.040 perm, 0.015 perm to 0.030 perm, or 0.02 to 0.035 perm), as measured by ASTM E96, for example at a film thickness of 0.508 mm (though embodiments can use other thicknesses). In some embodiments, the permeability characteristics of the PVC/2D filler films can be 2.1 perms/inch or less, 1.5 perms/inch or less, or permeability of 1.0 perms/inch or less (e.g., 2.1 perms/inch or less, 1.8 perms/inch or less, 1.3 perms/inch or less, 1.2 perms/inch or less, 0.8 perms/inch to 2.1 perms/inch, or 1.0 perms/inch to 2.0 perms/inch). The PVC/2D filler films disclosed can also offer excellent chemical stability, fire resistance, and longevity. The PVC/2D filler films disclosed also provide improved mechanical and physical properties at low temperatures and superior chemical stability when compared to conventional PVC membranes.

The disclosed PVC/2D filler films can also allow for the use of recycled or reground PVC, such as up to about 100 wt. % recycled or reground PVC (e.g. up to about 95 wt. %, up to about 90 wt. %, up to about 80 wt. %, up to about 70 wt. %, up to about 60 wt. %, up to about 50 wt. %, up to about 40 wt. %, up to about 35 wt. %, up to about 30 wt. %, up to about 25 wt. %, up to about 20 wt. % recycled or reground PVC, from about 10 wt. % to about 80 wt. %, from about 30 wt. % to about 70 wt. %, from about 1 wt. % to about 40 wt. %, from about 5 wt. % to about 35 wt. %, or from about 10 wt. % to about 30 wt. % recycled or reground PVC), for example. This can have significant benefits, such as cost savings.

In some aspects, the PVC/2D filler films described can have a thickness of greater than 0.01 mm, e.g., greater than 0.05 mm, greater than 0.1 mm, greater than 0.2 mm, greater than 0.3 mm, greater than 0.4 mm, or greater than 0.5 mm. In terms of ranges, in some embodiments the PVC/2D filler films described can have a thickness of from about 0.01 mm to about 5 mm, e.g., from about 0.05 mm to about 3 mm, from about 0.1 mm to about 2 mm, from about 0.1 mm to about 1 mm, or from about 0.2 mm to about 0.8 mm.

### PVC Resins

The PVC resins described include polyvinyl chloride resins in the form of pellets or dry blends, for example, that can be mixed with described fillers, additives, etc. The molecular weight of the PVC resin corresponds with the viscosity of the PVC resin, which is commonly measured as a K-value. In some embodiments, the PVC resins described can have a K-value of between 50 and 75, preferably a K-value of between 55 and 72, and more preferably a K-value of a between 57 and 69. As noted, the PVC resins can, in some embodiments, contain varying levels of recycled or reground material. In some aspects of the disclosure, the PVC resins can be processed to remove or reduce any hydrophilic components (fillers, additives, etc.) so as to improve the water vapor permeability of the PVC resins and the final film products. In some embodiments, any hydrophilic components in the PVC resins can be substituted with the described 2D fillers.

### 2D Filler

The 2D fillers described herein can be incorporated into the PVC resins at either the nano- or micro-scale. In some aspects, this can mean that the 2D fillers can have at least one of three dimensions in with a length in the nano-range (1-999 nm) or in the micro-range (1-999 μm). In some embodiments, the 2D fillers can be hydrophobic. The particles of the 2D filler can, in some embodiments, have an average length of at least one order of magnitude greater than their average thickness, e.g., an average length of at least 1.5 orders of magnitude greater than their average thickness, an average length of at least 2 orders of magnitude greater than their average thickness, or an average length of at least 3 orders of magnitude greater than their average thickness. The particles of the 2D filler can, in some embodiments, have an average width of at least one order of magnitude greater than their average thickness, e.g., an average width of at least 1.5 orders of magnitude greater than their average thickness, an average width of at least 2 orders of magnitude greater than their average thickness, or an average width of at least 3 orders of magnitude greater than their average thickness. In some embodiments, the at least one 2D filler can be present in an amount from about 0.01 wt. % to about 30 wt. % (e.g., from about 0.1 wt. % to about 25 wt. %, from about 0.5 wt. % to about 20 wt. %, from about 0.03 wt. % to about 9 wt. %, from about 0.05 wt. % to about 8 wt. %, or from about 0.1 wt. % to about 10 wt. %, from about 0.5 wt. % to about 10 wt. %, of from about 1 wt. % to about 10 wt. %), based on the total weight of the film. Examples of the 2D filler include, but are not limited to graphene, graphite, clay, mica, montmorillonite, boron nitride nanosheets, boron nanosheets (B NSs), hexagonal boron nitride (h-BN), graphene oxide (GO), reduced graphene oxide (rGO), silicate clays, layered double hydroxides (LDHs), transition metal dichalcogenides (TMDs), transition metal oxides (TMOs), black phosphorus (BP), graphitic carbon nitride (g-C3N4), antimonene (AM), and tin telluride nanosheets (SnTe NSs), or combinations thereof.

### Other Components

The PVC/2D filler film optionally also includes one or more high molecular weight processing aids, which can be an acrylic processing aid. The PVC/2D filler film optionally also includes a surfactant or dispersing agent, in order to improve the filler dispersion and distribution throughout the polymer matrix.

### PVC Products

The PVC/2D filler compositions disclosed can have many applications. In one embodiment, the PVC/2D filler compositions can be used in jacketing applications, e.g., to protect and insulate pipes. For example, the PVC/2D filler compositions can be used in low permeability pipe jackets. In some aspects, the low permeability pipe jackets described can have a water vapor permeance of 0.042 perm or less (e.g., 0.040 perm or less, 0.038 perm or less, 0.036 perm or less, 0.034 perm or less, 0.032 perm or less, 0.030 perm or less, 0.028 perm or less, 0.026 perm or less, 0.024 perm or less, 0.022 perm or less, 0.020 perm or less, 0.018 perm or less, 0.016 perm or less, 0.014 perm or less, 0.012 perm or less, 0.024 perm or less, 0.010 perm to 0.040 perm, or 0.015 perm to 0.030 perm), as measured by ASTM E96. In some embodiments, the permeability characteristics of the PVC/2D filler films can be 2.1 perms/inch or less, 2.0 perms/inch or less, 1.8 perms/inch or less, 1.5 perms/inch or less, 1.3 perms/inch or less, or permeability of 1.0 perms/inch or less. In terms of ranges, in some embodiments, the permeability of the PVC/2D filler films can be from 1.0 perms/inch to 2.1 perms/inch, e.g., from 1.0 perms/inch to 2.0 perms/inch, from 1.2 perms/inch to 2.0 perms/inch, or from 1.3 perms/inch to 1.8 perms/inch. In some aspects, the low permeability pipe jackets described can replace or substitute for metal pipe jackets.

In some embodiments, the disclosed low permeability pipe jackets described can include a cap layer that is positioned above or below the PVC/2D filler film (e.g., the core layer). In some embodiments, the cap layer may also be made of a PVC material, e.g., a PVC/2D filler material. However, in other embodiments, the cap layer does not contain 2D filler material. In some aspects, the cap layer may have the same composition as the core layer, while in some aspects, the cap layer may have a different composition than the core layer. In some embodiments, the cap layer may cover and protect the core layer (e.g., PVC core layer) from degradation, which, in some aspects may allow the cap layer to be made of lower grade materials in comparison with the PVC core layer. The PVC cap and/or PVC core may also include other materials, such as one or more pigment materials, fire retardants, antioxidant materials, antimicrobial materials, and combinations thereof.

The PVC/2D filler cap optionally also includes one or more process aids, such as an acrylic processing aid, that provides both improved processing and stability. When the products include a PVC/2D filler core, the PVC/2D filler core may include materials that are identical or similar to the PVC/2D filler cap materials described herein. In a specific embodiment, the PVC/2D filler core may include one or more of the following materials: heat stabilizers, one or more types of internal/external lubricants, one or more types of acrylic processing aids with different molecular weight, one or more types of acrylic impact modifiers, flame retardant, calcium carbonate, black pigment, color concentrates, recycled PVC, one or more types of 2D fillers, and the like. In some embodiments, the PVC/2D filler core and cap have different compositions or formulations based on their different functions.

As used herein, the PVC resin means a polyvinyl chloride resin in the form of pellets or dry blend, for example, that can be mixed with described fillers, and additives. As used herein, the 2D filler can refer to a hydrophobic filler wherein the filler particles can, in some embodiments, have an average length at least one order of magnitude greater than their average thickness.

The term heat stabilizer, or thermal stabilizer, as used herein, means a specific additive that is used in order to avoid thermal degradation and oxidation of the resin during processing. The term process aids as used herein, means a specific additive that is used to control the viscosity of the entire formulation during processing and molding operations.

Having described various aspects of the products and films generally, and in particular the PVC films, additional details of the PVC film structures will be readily apparent in relation to the description of the several figures, which is provided herein below.

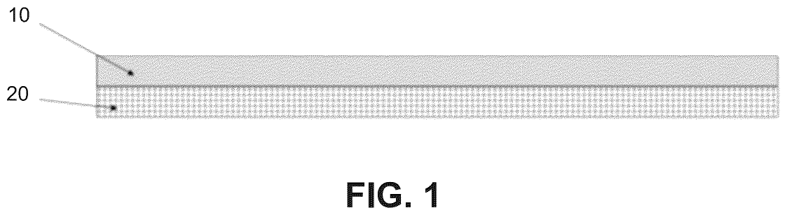

FIG. 1 illustrates a PVC film product that includes a PVC cap 10 and a PVC core (or bottom layer) 20. The core layer 20 may be formed of various materials. In a specific embodiment, the core layer 20 is formed of a PVC material. The core layer can also include a 2D filler as described above. For ease in describing the embodiments herein, the core layer 20 will be referred to hereinafter as a PVC core 20. The PVC core 20 is made of a different PVC material than the PVC cap 10, in some, but not all embodiments. For example, the PVC core 20 can, in some embodiments, be made of a lower grade PVC material than the PVC cap 10. In some instances, however, the PVC core 20 and the PVC cap 10 may be identical or nearly identical in composition.

The PVC core 20 forms a bottom layer of the film product. In some embodiments, the film product can be configured for positioning and attaching to an outer surface of a structure or pipe, e.g., a pipe jacket. In some embodiments, the PVC cap 10 is positioned atop the PVC core 20 and is coupled or joined to the PVC core 20 along a seam or interface between the materials. In some instances, the PVC cap 10 may be extruded onto the PVC core 20 during manufacturing of the two materials. In other embodiments, the PVC core 20 and PVC cap 10 may be formed separately and joined or laminated together at a later stage via adhesive or any other known boding technique known or otherwise developed in the art.

The PVC cap 10 forms a top layer of the film product (e.g., jacket) and is typically exposed to an external environment. The PVC cap 10 performs various functions, such as water proofing the jacket and the underlying structure or pipe, minimizing degradation of the system components, such as from exposure, providing a desired visual appearance, and the like. In some aspects, the upper surface of the PVC cap 10 can be smooth and visually appealing. A smooth upper surface, as described herein, means that the surface does not include significant visible indications of roughness or non-smoothness, or any significant surface inconsistency. Visually unappealing films include wrinkling, roughness, and other visual features that are commonly referred to as “chevrons”. The PVC cap formulations described herein can, in some embodiments, avoid surface inconsistencies, chevrons, and the like, which renders the PVC cap 10 more visually appealing.

In some embodiments, the PVC cap 10 includes or consists of a polyvinyl chloride resin (PVC resin), a 2D filler, optionally one or more processing aids, and optionally one or more additive materials. The PVC resin may have a molecular weight expressed as a K-value, of between 50-75, 58-72, 65-69, or 67-69, for example The processing aid may be an acrylic processing aid. When the PVC resin is mixed and compounded with the 2D filler, the liquid plasticizer and/or solid plasticizer, and other additives and fillers, a final “compound” is obtained where the liquid plasticizer can be stable in a solid state, for example. The PVC resin can be softened due to the presence of the plasticizers. The final product can be uniform and stable under standard conditions.

The optional acrylic processing aid, including fusion aids and lubricating processing aids, may be a high molecular weight lubricant. Examples of suitable process aids include the product Plastistrength® sold by Arkema S.A.®, the product Paraloid® sold by The Dow Chemical Company®, and the product PlastiStab® sold by AM Stabilizers Corporation®. The additives that may be used in the PVC cap 10 may include a heat stabilizer, a heat co-stabilizer, Examples of suitable additive materials include lubricant, acrylic processing aids, a flame retardants, calcium carbonate, a color concentrate, recycled PVC, and the like. The result of the above-described combination of materials results in a high quality PVC sheet that is both aesthetically pleasing and highly functional.

In one embodiment, the PVC cap 10 is formed of a lower molecular weight PVC resin, which is balanced with a specific choice of liquid plasticizers. In such embodiments, the molecular weight of the PVC resin expressed as a K-value, of between 50-75, 58-72, 65-69, or 67-69. The PVC cap 10 may include between 50 and 80 weight percent of the PVC resin and between 0.01 and 10 weight percent of a 2D filler. The PVC cap 10 can also be formed via one or more processing aids in some embodiments, which may be applied in an amount between 0.5 and 5 weight percent of the total weight of the compound. In some embodiments, one or more additives as described herein, may also be used in forming the PVC cap 10. The additives may be applied in an amount between 0.5 and 15 weight percent of the total weight of the compound.

In other embodiments, the PVC cap 10 is formed of a lower molecular weight PVC and one or more solid plasticizers. The molecular weight of the PVC resin expressed as a K-value, of between 50-75, 58-72, 65-69, or 67-69. The PVC cap 10 may include between 50 and 80 weight percent of the PVC resin.

In a specific embodiment, the film product includes, or consists of, a PVC core 20 and a PVC cap 10 in which the PVC core 20 includes, or consists of, PVC resin (100 PHR), a heat stabilizer (3-4 PHR one or more additives (lubricant, antioxidant, and antimicrobial) (1.0-1.8 PHR), an acrylic processing aid (2 PHR), a black pigment (0.2 PHR), a fire retardant (3-5 PHR), and calcium carbonate (12-14 PHR), and in which the PVC cap 10 includes, or consists of, PVC resin (100 PHR), a heat stabilizer (3-4 PHR), one or more additives (lubricant, UV stabilizer, antioxidant, antimicrobial) (1-4 PHR), an acrylic processing aid (1.5-3 PHR), a fire retardant (3-4 PHR), a pigment and calcium carbonate (8-12 PHR).

In some embodiments, the PVC core 20 may have a thickness of between 5 and 100 mils (i.e., between 0.1 and 3.0 mm) and the PVC cap 10 may have a thickness of between 5 and 100 mils (i.e., between 0.1 and 3.0 mm). In some embodiments, the thickness of the PVC core 20 is greater than the PVC cap 10 because the main function of the PVC cap 10 is to cover, conceal, and protect the PVC core 20 and underlying materials. However, in some embodiments, the PVC cap 10 is at least 0.3 mm thick in order to ensure the formation of a smooth, visually appealing, top surface and prevent nervy, wavy, or unappealing features of the PVC core 20 from being visible through the PVC cap 10. The film may have essentially any length and width as required by customer or engineer specifications.

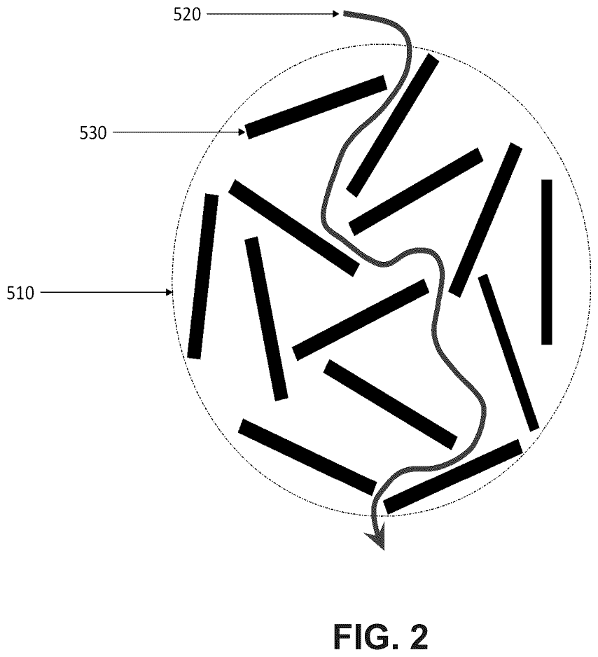

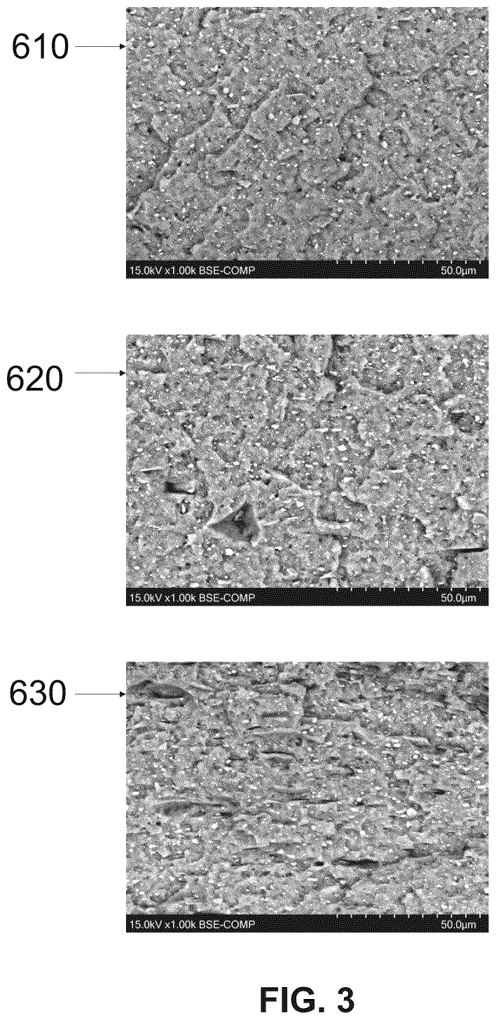

Referring now to FIG. 2, illustrated is a PVC film product 510 that includes a 2D filler 530. FIG. 3 shows a cross sectional representative region of the PVC film product 510 filled with 2D filler 530. The 2D filler 530 is positioned in the matrix of the PVC film product 510. FIG. 2 shows the water vapor flow path 520 through the PVC film product 510. The 2D filler 530 forces the water vapor to take a tortuous path through the film product, as FIG. 2 illustrates, decreasing the permeability of the PVC film product 510.

Referring now to FIG. 3, shown are scanning electron microscope (“SEM”) images of PVC films. 610 shows a PVC film section with no 2D fillers. 610 can be considered the control image. 620 shows a PVC film section with clay (2X) added as a 2D filler. 630 shows a PVC film section with graphene (2X) added as a 2D filler. As explained with respect to FIG. 2, the SEM images 620 and 630 show how the 2D filler can increase the tortuosity of water vapor through the PVC films and consequently decrease the permeability of the PVC films.

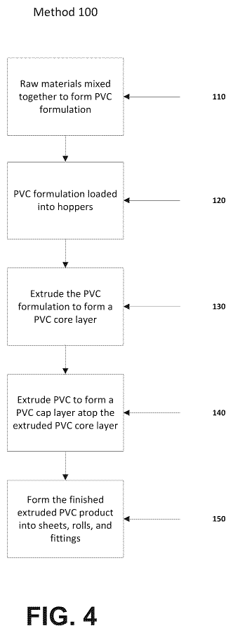

Referring to FIG. 4, illustrated is a method 100 of making or forming a film product. At block 110, the raw materials which make up the rigid PVC dry blend formula are mixed together. At block 120, the blended rigid PVC formulation is loaded into hoppers for processing. Block 130 shows a first polyvinyl chloride (PVC) material and at least one 2D filler is extruded to form a PVC/2D filler core layer of the film product. In some embodiments this PVC/2D filler core layer is the film product. In other embodiments like the one shown in FIG. 4, at block 140, a second PVC material is extruded atop the PVC core layer to form a PVC cap layer of the film product. As described herein, the PVC cap layer may include or consist of a polyvinyl chloride resin having a molecular weight as described herein and a solid polymeric plasticizer having a having a molecular weight as described herein. The cap layer can, in some embodiments, further comprise the same or different 2D filler. In other embodiments, the cap layer does not comprise a 2D filler. In some embodiments, the PVC cap layer may include between 50 and 80 weight percent of the polyvinyl chloride resin and between 0.01 and 10 weight percent of a 2D filler. In some embodiments, the cap layer can further comprise between 1 and 50 weight percent of a polymeric plasticizer. In some embodiments, the PVC cap layer can preferably include between 10 and 35 weight percent of the polymeric plasticizer and more preferably between 18 and 25 weight percent of the polymeric plasticizer. The PVC cap layer may have any composition described herein. Likewise, the PVC core may have any composition described herein. Block 150 describes the final step of molding fittings out of the rigid PVC material.

### Examples

In order to compare the described films to the conventional products, 20 mil thick smooth PVC films were prepared including both control PVC blends and PVC/2D filler compositions as described. Table 1 shows the samples prepared and the permeance measure for the samples according to ASTM E96.

TABLE 1

| | | Permeance | Permeability | Recycled |
|---|---|---|---|---|
| | Formulation | (US perms) | (US perms/inch) | PVC |
| Comparative | PVC | 0.047 | 2.35 | No |
| Example 1 | | | | |
| Comparative | PVC | 0.045 | 2.25 | 25 wt. % |
| Example 2 | | | | |
| Example 1 | PVC + 2.1 wt. % | 0.030 | 1.5 | No |
| | graphene | | | |
| Example 2 | PVC + 5.1 wt. % | 0.030 | 1.5 | No |
| | graphene | | | |
| Example 3 | PVC + 2.1 wt. % | 0.041 | 2.05 | No |
| | Clay | | | |
| Example 4 | PVC + 5.1 wt. % | 0.042 | 2.1 | No |
| | Clay | | | |

While a slight increase in stiffness was observed when incorporating 5.1 wt. % graphene, the vapor permeance of the sample was reduced by approximately 40% for the addition of 2.1 wt. % graphene and 5.1 wt. %. Significant decreases in vapor permeance were also observed with the addition of clay (2.1 wt. % and 5.1 wt. %) over the comparative examples.

As used below, any reference to a series of examples is to be understood as a reference to each of those examples disjunctively (e.g., “Examples 1-4” is to be understood as “Examples 1, 2, 3, or 4”).

Example 1 is a film, comprising: polyvinyl chloride (PVC); and a 2D filler incorporated in the PVC at the micro- or nano-scale; wherein the film has a water vapor permeance as measured by ASTM E96 of 0.042 perm or less; and wherein the film has a water vapor permeability of 2.1 perms/inch or less.

Example 2 is the film of claim 1, wherein the PVC of the film is processed to reduce any filler or additive that is hydrophilic.

Example 3 is the film of any of the preceding examples, wherein the 2D filler is present in an amount from 0.01 wt. % to 30 wt. %, based on the total weight of the film.

Example 4 is the film of any of the preceding examples, wherein the 2D filler comprises graphene, graphite, clay, mica, montmorillonite, boron nitride nanosheets, boron nanosheets (B NSs), hexagonal boron nitride (h-BN), graphene oxide (GO), reduced graphene oxide (rGO), silicate clays, layered double hydroxides (LDHs), transition metal dichalcogenides (TMDs), transition metal oxides (TMOs), black phosphorus (BP), graphitic carbon nitride (g-C3N4), antimonene (AM), and tin telluride nanosheets (SnTe NSs), or combinations thereof.

Example 5 is a film product, comprising: a core layer comprising polyvinyl chloride (PVC); and a cap layer positioned atop the PVC core layer so that the cap layer forms a top layer comprising PVC; wherein at least one of the core layer and the cap layer further comprises a 2D filler incorporated at the micro- or nano-scale; and wherein the film product has a water vapor permeance as measured by ASTM E96 of 0.030 perm or less.

Example 6 is the film product of any of the preceding examples, wherein the PVC of at least one of the core layer and the cap layer is processed to reduce any filler or additive that is hydrophilic.

Example 7 is the film product of any of the preceding examples, wherein both the PVC of the core layer and the PVC of the cap layer are processed to reduce any filler or additive that is hydrophilic.

Example 8 is the film product of any of the preceding examples, wherein both the core layer and the cap layer comprise a 2D filler incorporated at the micro or nano scale.

Example 9 is the film product of any of the preceding examples, wherein the 2D filler is present in an amount from 0.01 wt. % to 30 wt. %, based on the total weight of the layer.

Example 10 is the film product of any of the preceding examples, wherein the 2D filler comprises graphene, graphite, clay, mica, montmorillonite, boron nitride nanosheets, boron nanosheets (B NSs), hexagonal boron nitride (h-BN), graphene oxide (GO), reduced graphene oxide (rGO), silicate clays, layered double hydroxides (LDHs), transition metal dichalcogenides (TMDs), transition metal oxides (TMOs), black phosphorus (BP), graphitic carbon nitride (g-C3N4), antimonene (AM), and tin telluride nanosheets (SnTe NSs), or combinations thereof.

Example 11 is the film product of any of the preceding examples, wherein the core layer has a thickness of from 5 microns (0.1 mm) to 100 microns (3.0 mm).

Example 12 is the film product of any of the preceding examples, wherein the cap layer has a thickness of from 5 microns (0.1 mm) to 100 microns (3.0 mm).

Example 13 is the film product of any of the preceding examples, wherein the PVC of at least one of the core layer or the cap layer comprises between 5 wt. % and 100 wt. % recycled PVC.

Example 14 is the film product of any of the preceding examples, wherein at least one of the cap layer or the core layer further comprises a surfactant, dispersing agent or coupling agents.

Example 15 is the film product of any of the preceding examples, wherein at least one of the cap layer or the core layer further comprises a surfactant.

Example 16 is the film product of any of the preceding examples, wherein the surfactant comprises a cationic surfactant, an anionic surfactant, a zwitterionic surfactant, a nonionic surfactant, or combinations thereof.

Example 17 is the film product of any of the preceding examples, wherein at least one of the cap layer or the core layer comprises a dispersing agent.

Example 18 is the film product of any of the preceding examples, wherein the film product has a water vapor permeance as measured by ASTM E96 of 0.030 perm or less and wherein the film has a water vapor permeability of 1.5 perms/inch or less.

Example 19 is the film product of any of the preceding examples, wherein the film product has a water vapor permeance as measured by ASTM E96 of 0.02 perm or less.

Example 20 is the film product of any of the preceding examples, wherein the 2D filler has an average particle size of 50 nm to 10 μm.

Example 21 is the film product of any of the preceding examples, wherein the 2D filler has an aspect ratio of 10 to 10,000, as measured by the ratio between the larger size and the smaller size.

Example 22 is a low vapor permeance pipe jacket comprising, a core layer comprising polyvinyl chloride (PVC); and a cap layer comprising PVC and positioned atop the PVC core layer so that the cap layer forms an outer layer; wherein at least one of the core layer and the cap layer further comprises a 2D filler incorporated at the micro- or nano-scale; and wherein the sheet has a water vapor permeance as measured by ASTM E96 of 0.030 perm or less; and wherein the film has a water vapor permeability of 1.5 perms/inch or less.

Example 23 is the low vapor permeance pipe insulation jacket of any of the preceding examples, wherein the PVC of at least one of the core layer and the cap layer is processed to reduce any filler or additive that is hydrophilic.

Example 24 is a method of making a low vapor permeance pipe insulation jacket, the method comprising: processing a polyvinyl chloride (PVC) sample to reduce any filler or additive that is hydrophilic to form a processed PVC material; compounding the processed PVC material and a first 2D filler to form a first compounded material; compounding the processed PVC material and a second 2D filler to form a second compounded material; extruding the first compounded material to form a core layer of the insulation jacket; extruding the second compounded material atop the core layer to form a cap layer of the insulation jacket; wherein the insulation jacket has a water vapor permeance as measured by ASTM E96 of 0.030 perm or less, and wherein the film has a water vapor permeability of 1.5 perms/inch or less.

Example 25 is the method according to any of the preceding examples, further comprising optimizing the conditions of the compounding steps to decrease permeability of the cap and core layers.

Example 26 is the method according to any of the preceding examples, further comprising optimizing the extrusion steps to decrease permeability of the cap and core layers.

Example 27 is the method according to any of the preceding examples, wherein optimizing the extrusion steps comprises inducing an orientation of the 2D filler.

Example 28 is the method according to any of the preceding examples, wherein the first 2D filler and the second 2D filler are the same.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the device” includes reference to one or more devices and equivalents thereof known to those skilled in the art, and so forth.

This disclosure encompasses all thicknesses of PVC and PVC/2D filler films. This can include, for example, films, sheets, and layers. When any of these terms are used in this disclosure, it should be understood that the term can also be referring to similar structures. For example, when the term “films” is used herein, it also refers to sheets, layers, etc.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A film, comprising:
polyvinyl chloride (PVC); and
a 2D filler incorporated in the PVC at the micro- or nano-scale;
wherein the film has a water vapor permeance as measured by ASTM E96 of 0.042 perm or less; and
wherein the film has a water vapor permeability of 2.1 perms/inch or less.

2. The film of claim 1, wherein the PVC of the film is processed to reduce any filler or additive that is hydrophilic.

3. The film of claim 1, wherein the 2D filler is present in an amount from 0.01 wt. % to 30 wt. %, based on the total weight of the film.

4. The film of claim 1, wherein the 2D filler comprises graphene, graphite, clay, mica, montmorillonite, boron nitride nanosheets, boron nanosheets (B NSs), hexagonal boron nitride (h-BN), graphene oxide (GO), reduced graphene oxide (rGO), silicate clays, layered double hydroxides (LDHs), transition metal dichalcogenides (TMDs), transition metal oxides (TMOs), black phosphorus (BP), graphitic carbon nitride (g-C3N4), antimonene (AM), and tin telluride nanosheets (SnTe NSs), or combinations thereof.

5. A film product, comprising:
a core layer comprising polyvinyl chloride (PVC); and
a cap layer positioned atop the PVC core layer so that the cap layer forms a top layer comprising PVC;
wherein at least one of the core layer and the cap layer further comprises a 2D filler incorporated at the micro- or nano-scale; and
wherein the film product has a water vapor permeance as measured by ASTM E96 of 0.030 perm or less.

6. The film product of claim 5, wherein the PVC of at least one of the core layer and the cap layer is processed to reduce any filler or additive that is hydrophilic.

7. The film product of claim 6, wherein both the PVC of the core layer and the PVC of the cap layer are processed to reduce any filler or additive that is hydrophilic.

8. The film product of claim 5, wherein both the core layer and the cap layer comprise a 2D filler incorporated at the micro or nano scale.

9. The film product of claim 5, wherein the 2D filler is present in an amount from 0.01 wt. % to 30 wt. %, based on the total weight of the layer.

10. The film product of claim 5, wherein the 2D filler comprises graphene, graphite, clay, mica, montmorillonite, boron nitride nanosheets, boron nanosheets (B NSs), hexagonal boron nitride (h-BN), graphene oxide (GO), reduced graphene oxide (rGO), silicate clays, layered double hydroxides (LDHs), transition metal dichalcogenides (TMDs), transition metal oxides (TMOs), black phosphorus (BP), graphitic carbon nitride (g-C3N4), antimonene (AM), and tin telluride nanosheets (SnTe NSs), or combinations thereof.

11. The film product of claim 5, wherein the core layer has a thickness of from 5 microns (0.1 mm) to 100 microns (3.0 mm).

12. The film product of claim 5, wherein the cap layer has a thickness of from 5 microns (0.1 mm) to 100 microns (3.0 mm).

13. The film product of claim 5, wherein the PVC of at least one of the core layer or the cap layer comprises between 5 wt. % and 100 wt. % recycled PVC.

14. The film product of claim 5, wherein at least one of the cap layer or the core layer further comprises a surfactant, dispersing agent or coupling agents.

15. The film product of claim 14, wherein at least one of the cap layer or the core layer further comprises a surfactant.

16. The film product of claim 15, wherein the surfactant comprises a cationic surfactant, an anionic surfactant, a zwitterionic surfactant, a nonionic surfactant, or combinations thereof.

17. The film product of claim 1, wherein at least one of the cap layer or the core layer comprises a dispersing agent.

18. The film product of claim 5, wherein the film product has a water vapor permeance as measured by ASTM E96 of 0.030 perm or less and wherein the film has a water vapor permeability of 1.5 perms/inch or less.

19. The film product of claim 5, wherein the film product has a water vapor permeance as measured by ASTM E96 of 0.02 perm or less.

20. The film product of claim 5, wherein the 2D filler has an average particle size of 50 nm to 10 μm.

21. The film product of claim 5, wherein the 2D filler has an aspect ratio of 10 to 10,000, as measured by the ratio between the larger size and the smaller size.

22. A low vapor permeance pipe jacket comprising,
a core layer comprising polyvinyl chloride (PVC); and
a cap layer comprising PVC and positioned atop the PVC core layer so that the cap layer forms an outer layer;
wherein at least one of the core layer and the cap layer further comprises a 2D filler incorporated at the micro- or nano-scale; and
wherein the sheet has a water vapor permeance as measured by ASTM E96 of 0.030 perm or less; and
wherein the film has a water vapor permeability of 1.5 perms/inch or less.

23. The low vapor permeance pipe insulation jacket of claim 22, wherein the PVC of at least one of the core layer and the cap layer is processed to reduce any filler or additive that is hydrophilic.

24. A method of making a low vapor permeance pipe insulation jacket, the method comprising:
processing a polyvinyl chloride (PVC) sample to reduce any filler or additive that is hydrophilic to form a processed PVC material;
compounding the processed PVC material and a first 2D filler to form a first compounded material;
compounding the processed PVC material and a second 2D filler to form a second compounded material;
extruding the first compounded material to form a core layer of the insulation jacket;
extruding the second compounded material atop the core layer to form a cap layer of the insulation jacket;
wherein the insulation jacket has a water vapor permeance as measured by ASTM E96 of 0.030 perm or less, and
wherein the film has a water vapor permeability of 1.5 perms/inch or less.

25. The method of claim 24, further comprising optimizing the conditions of the compounding steps to decrease permeability of the cap and core layers.

26. The method of claim 24, further comprising optimizing the extrusion steps to decrease permeability of the cap and core layers.

27. The method of claim 26, wherein optimizing the extrusion steps comprises inducing an orientation of the 2D filler.

28. The method of claim 24, wherein the first 2D filler and the second 2D filler are the same.
